(19) United States
(12) Patent Application Publication
(10) Pub. No.: US 2015/0286326 A1
(43) Pub. Date: Oct. 8, 2015

(54) RECONFIGURABLE FIXED FUNCTION, NBC COMPATIBLE INTEGRATED DISPLAY AND SWITCH SYSTEM

(71) Applicant: Korry Electronics Co., Everett, WA (US)

(72) Inventors: Michael Y. Utsugi, Seattle, WA (US); Shawn M. Doyea, Seattle, WA (US); Dale T. Iwasa, Everett, WA (US)

(21) Appl. No.: 14/666,099

(22) Filed: Mar. 23, 2015

Related U.S. Application Data
(63) Continuation of application No. 13/214,038, filed on Aug. 19, 2011, now abandoned.

(51) Int. Cl. G06F 3/041; G06F 3/02; G06F 1/16; G06F 3/01

(52) U.S. Cl. CPC G06F 3/0412; G06F 3/016; G06F 3/0219; G06F 1/1643

(57) ABSTRACT

A reconfigurable display system is provided that has an electronic display operatively coupled to a computer and having a display active area and peripheral portions. A touch screen is sealably coupled with the display and extends over the electronic display. The touch screen has touch portions adjacent to the peripheral portions of the electronic display. The touch screen provides touch-receiving portions to receive touch inputs and deliver the touch inputs to the computer or the electronic display. The sealed touch screen display assembly is washable and decontaminatable. A boarder assembly is removeably connected to the touch screen display assembly. The boarder assembly has a boarder portion adjacent to the touch portions of the touch screen. A plurality of actuatable keys is carried by the boarder portion and in alignment with the touch-receiving portions of the touch screen. The keys are removeable from the sealed touch screen display assembly, and the keys are configured to provide a touch inputs to the touch-receiving portions of the touch screen when the keys are actuated by a user.

### CROSS REFERENCE TO RELATED APPLICATIONS

This application is a continuation of U.S. patent application Ser. No. 13/214,038, filed Aug. 19, 2011, entitled “RECONFIGURABLE FIXED FUNCTION, NBC COMPATIBLE INTEGRATED DISPLAY SYSTEM,” (Attorney Docket No. 27329-7695.US01). This application is related to U.S. patent application Ser. No. 13/213,998, filed Aug. 19, 2011, entitled “RECONFIGURABLE FIXED FUNCTION, NBC COMPATIBLE INTEGRATED DISPLAY SYSTEM,” (Attorney Docket No. 27329-7695.US00), and U.S. Design patent application Ser. No. 29/399,916, filed Aug. 19, 2011, entitled “INTEGRATED TOUCH SCREEN DISPLAY,” (Attorney Docket No. 27329-7697.US00). All of the applications listed above are incorporated by reference herein in their entireties.

### TECHNICAL FIELD

This invention is directed to a reconfigurable, modular touch screen display system, and associated methods of manufacture and assembly.

### BACKGROUND

Conventional mobile or on-board computers with integrated display systems provide convenient access to information, such as maps, weather, and other useful information. A desirable way to display this information is with an in-dash display that operates much like a mobile computer monitor. Some designs incorporate touch screen user interface technology with predetermined switch functions and integrated switches or switch panels. In military applications, these on-board displays are useful for communicating mission-specific information to the vehicle occupants as the vehicle travels into remote locations. Many conventional display assemblies, however, are undesirable for many military applications. For example, military gear should comply with standards for nuclear, biological, and chemical (NBC) standards for washability and survivability, such as the standards set forth in Army Regulations 70-75, which are incorporated herein by reference in their entireties. Another undesirable aspect of conventional display assemblies is the functionality of the on-board display/computer may be suitable for one mission-specific activity but not for another. This limitation results in additional time and resources to reconfigure a vehicle for each new mission-specific activity.

These NBC standards include specifications defining how a given product or material must avoid carrying NBC contaminants on surfaces or in crevices of the product or material. Many conventional devices include attempt to comply with the standards by fully sealing the device, such as a display device having hard, sealed keys, from an external environment to prevent the NBC contaminants from entering the device. These sealed devices are configured to be washable to remove NBC contaminants from the devices without adversely affecting the internal electronic components. However, these systems are typically difficult and expensive to manufacture, and the external seals can be subject to failure leading to a breach of the perimeter. Another drawback is that the hard switches in sealed systems are typically configured at the time of manufacture with a specific functionality or design in mind, and are not easily adjustable later. These types of sealed assemblies are typically unable to accommodate further designs and changes of designs later during use. Substantive design changes, such as changes based upon customer needs or product modifications, can require substantive product redesign. Design changes that occur during or after product development, particularly late in the product development process, can be expensive and can cause substantial time delays. Accordingly, the conventional devices lack adequate flexibility to handle product reconfiguration required because of customer needs or mission specific needs.

The development of military mission-specific display/computer assemblies is expensive in terms of development time and costs. It is desirable to develop a general purpose computer system where the user function interface portion can be easily changed in the field and with mission-specific application loaded, allowing rapid redeployment to the field.

Although touch screen technology is rapidly becoming commonplace, touch screen systems typically lack tactile feedback. In some applications this lack of tactile feedback from such touch screen devices is less desirable. For example, in some military applications in which personnel wear heavy gloves or other clothing, it is difficult to operate a display device without tactile feedback. There is a need in the art for a modifiable device that meets NBC standards for washability and survivability, that can be easily and quickly reconfigured, that provides convenient access to information, and that is operable in rugged environments.

### BRIEF DESCRIPTION OF THE DRAWINGS

FIG. 1A illustrates a display and an overlay system configured according to embodiments of the present disclosure.

FIG. 1B illustrates an exploded view of the display and overlay system of FIG. 1A.

FIG. 1C illustrates a cross-sectional top view of the display and overlay system of FIG. 1A.

FIG. 1D illustrates a cross-sectional top view of a display and overlay system configured according to embodiments of the present disclosure.

FIG. 2A illustrates a touch screen display system configured according to embodiments of the present disclosure.

FIG. 2B illustrates an exploded view of the touch screen display system of FIG. 2A.

FIG. 2C illustrates a cross-sectional top view of the touch screen display system of FIG. 2A.

Appendix A includes figures showing various views of the display and overlay system and the touch screen display system, including ornamental aspects thereof.

### DETAILED DESCRIPTION

The present disclosure describes a reconfigurable display and switch system in accordance with certain embodiments of the present invention. Several specific details of the invention are set forth in the following description and the Figures to provide a thorough understanding of certain embodiments of the invention. One skilled in the art, however, will understand that the present invention may have additional embodiments, and that other embodiments of the invention may be practiced without several of the specific features described below.

The touch screen display assembly and a removeable boarder assembly with actuatable keys in accordance with embodiments disclosed herein can be quickly and easily reconfigured. Embodiments can also comply with nuclear, biological, and chemical (NBC) standards for washability and survivability. A reconfigurable display/touch screen assembly can have a sealed touch-screen user interface, and a boarder assembly with a plurality of actuatable keys positioned over the sealed touch-screen user interface. The keys are operably coupled to the exterior of the touch-screen user interface such that when the keys are actuated, the keys deliver an input to the touch-screen user interface. The keys can also be configured to provide tactile feedback to the user upon delivery of the input to the touch screen interface. Embodiments can include an overlay positioned over the sealed touch-screen user interface and under the boarder assembly. The overlay can be held in place over the display and the touch-screen user interface by a frame. The overlay and boarder assembly can be compatible with NBC standards of washability and survivability. The overlay and/or the boarder assembly can be removable, replaceable, and/or disposable without affecting the integrity of the sealed touch-screen user interface.

In some embodiments, the present disclosure is directed to a reconfigurable display system is provided that has an electronic display operatively coupled to a computer and having a display active area and peripheral portions. In one embodiment a reconfigurable display system coupleable to a computer and having a sealed touch screen display assembly that comprises an electronic display operatively coupleable to the computer. The electronic display has a display active area and peripheral portions adjacent to the display active area. A touch screen is sealably coupled with the display and extends over the electronic display. The touch screen has touch portions adjacent to the peripheral portions of the electronic display and positioned to avoid obscuring the display active areas. The touch screen is configured to provide touch-receiving portions to receive touch inputs and deliver the touch inputs to the computer or the electronic display. The sealed touch screen display assembly can be washable and decontaminatable. A boarder assembly is removeably connected to the touch screen display assembly. The boarder assembly has a boarder portion adjacent to the touch portions of the touch screen. A plurality of actuatable keys is carried by the boarder portion and in alignment with the touch-receiving portions of the touch screen. The keys are configured to provide a haptic response upon actuation, and the keys are removeable from the sealed touch screen display assembly. The keys are configured to provide a touch inputs to the touch-receiving portions of the touch screen when the keys are actuated by a user.

In another embodiment, a mobile display system for use with a computer, comprises an electronic display operatively coupled to the computer. A touch screen is disposed on the electronic display. The touch screen has touch portions adjacent to the electronic display. The touch screen is configured to provide touch-receiving portions to receive touch inputs and deliver the touch inputs to the computer or the electronic display. The touch screen and electronic display are sealably connected together to form a sealed display/touch screen assembly configured to be washable and compatible with nuclear, biological, and chemical (NBC) standards for washability and survivability. A bezel is removably connected to the display/touch screen assembly. A plurality of actuatable keys is connected to the bezel and removeably positioned adjacent to the touch-receiving portions. The keys being actuatable to apply touch inputs to the touch-receiving portions. The keys being configured to provide a haptic response upon actuation.

In another embodiment, a reconfigurable boarder assembly for a sealed display and touch screen module, comprises a bezel shaped to cover a periphery of the display and touch screen module. The bezel has a plurality of apertures. A plurality of discrete actuatable keys fit within the apertures of the bezel. The bezel retains the actuatable keys immediately adjacent to touch-receiving portions of a touch screen of the display and touch screen module. The actuatable keys provide a haptic response and/or an audible feedback when actuated. The actuatable keys are configured to contact the touch screen input module when actuated. The bezel and actuatable keys are removable from display and touch screen module and at least one of disposable and washable according to nuclear, biological, and chemical (NBC) standards.

In another embodiment, a touch screen extends over the electronic display and has touch portions adjacent to the peripheral portions. The touch screen provides touch-receiving portions to receive touch inputs and deliver the touch inputs to the computer or the electronic display. An overlay is removably disposed on the touch screen covering at least the touch portions. A plurality of actuatable keys are adjacent to the touch screen and in alignment with the touch-receiving portions of the touch screen. The keys provide touch inputs to the touch-receiving portions when the keys are actuated by a user. A frame secured to the touch screen or the electronic display is positioned over the overlay with the overlay intermediate the frame and the touch screen. The overlay, keys, and the frame are removable from the touch screen.

In some embodiments, a reconfigurable display system is provided that includes an electronic display, and a touch screen module operably coupled to the electronic display and configured to receive touch inputs and deliver the touch inputs to the electronic display, a computer or other device. The display system can also include an overlay made of a sheet of flexible material, and the overlay is positioned over at least a portion of the touch screen having touch-receiving portions. The overlay has a plurality of actuatable keys that provide a tactile feedback to a user when actuated. The overlay is configured to convey touch inputs from the actuatable keys, through the overlay, to the touch-receiving portions of the touch screen module. The display can also include a frame positioned over the overlay to secure the overlay to the touch screen module, wherein the overlay and the frame are consistent with NBC regulations for washability and survivability.

In other embodiments, the present disclosure is directed to a reconfigurable overlay for a display system. The overlay can include a sheet of material compatible with NBC standards for washability and survivability, and having a plurality of actuatable portions, such as keys. The overlay can also include a frame configured to engage the overlay sheet and fasten the overlay sheet to an electronic display configured to receive touch inputs. The actuatable keys of the overlay sheet are positioned over at least a portion of the electronic display and configured to transmit touch inputs from a user to the electronic display.

In still further embodiments, the present disclosure is directed to an overlay for a display and touch screen input module. A bezel is attached to the touch screen and/or the overlay, such that the bezel covers a periphery of the touch screen that includes touch-receiving portions operatively coupled to the display. The bezel can have a plurality of apertures aligned with some or all of the touch-receiving portions of the touch screen. The bezel includes a plurality of discrete actuatable keys (i.e., buttons, or other input features) within the apertures. The keys are configured to engage the overlay at the touch-receiving portions. The bezel secures the actuatable keys to the touch screen in predetermined positions relative to touch-receiving portions, and the actuatable keys can provide a tactile feedback, an audible feedback, or both when actuated. The actuatable keys are configured to contact the overlay so as to effectively “touch” the touch screen when actuated. The overlay, the bezel and actuatable keys can be washable and removable according to NBC standards.

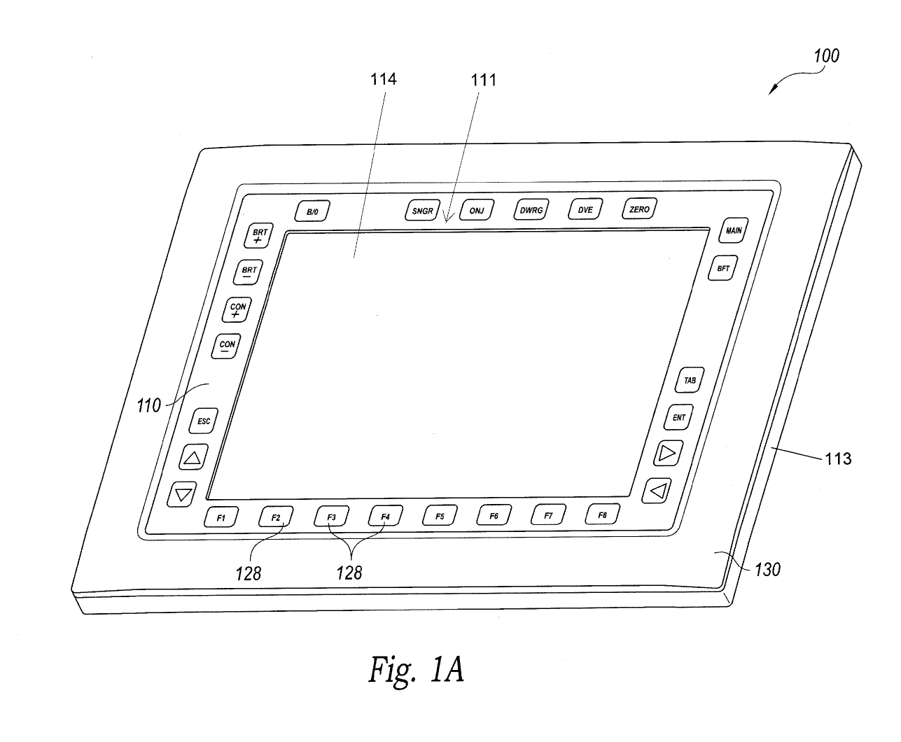

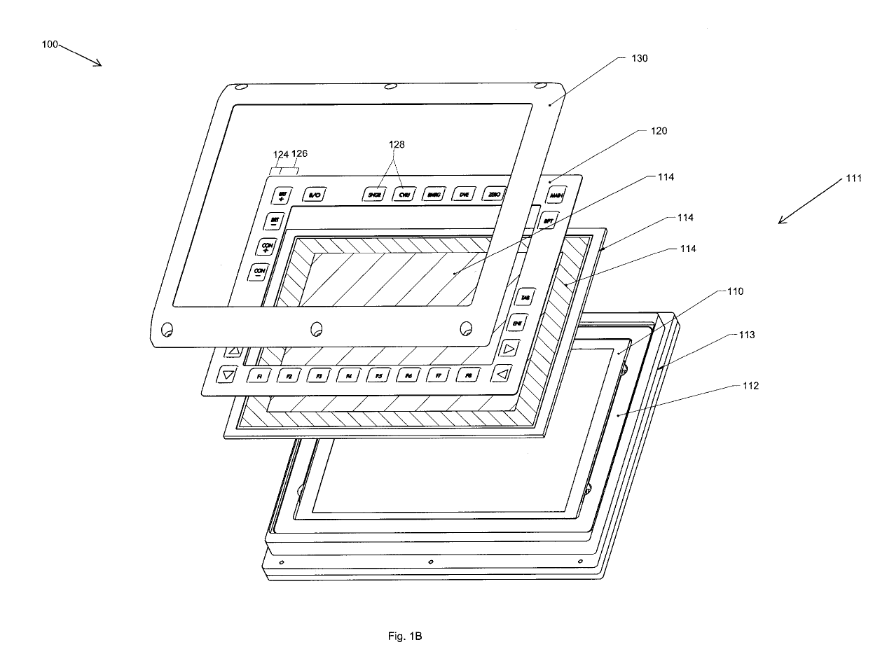

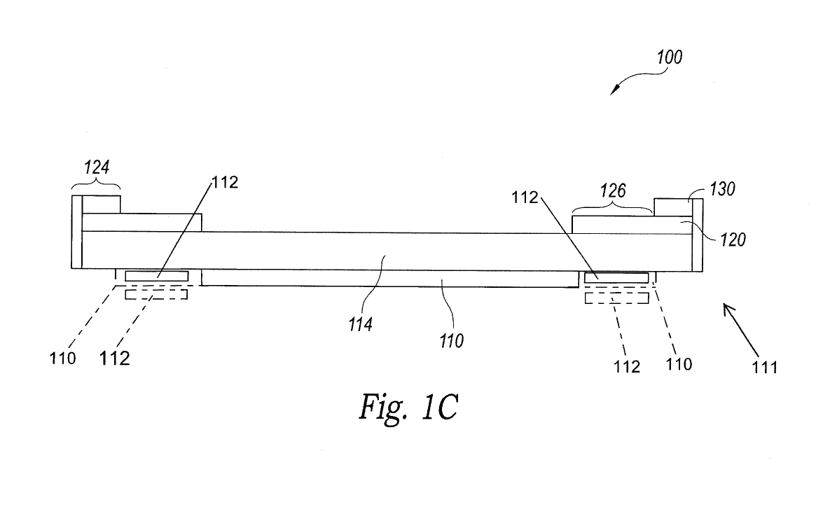

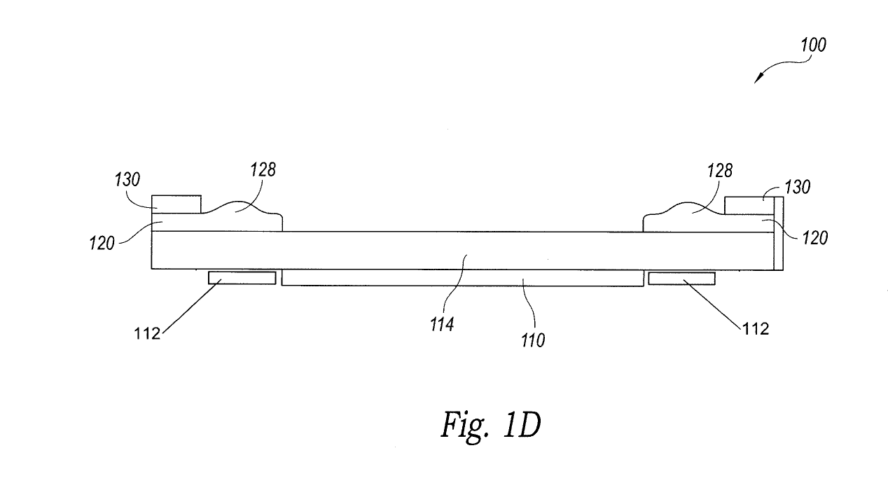

FIG. 1A illustrates a display overlay system 100 configured according to embodiments of the present disclosure. The display overlay system 100 can include a display 110 coupled to computer (e.g., a ruggedized mobile computer), a housing 113, a touch screen 114 operatively coupled to the display 110, an overlay 120 covering at least a portion of the touch screen 114, a plurality of actuatable keys 128 on the overlay 120, and a bezel or frame 130 positioned over at least a portion of the overlay 120 to secure the overlay 120 to the touch screen 114 and/or the display 110. In the illustrated embodiment, the touch screen 114 and the display 110 are coupled together to provide a touch screen/display assembly 111 configured to accept touch-based inputs from a user. The touch screen/display assembly 111 can be fully sealed during manufacturing so as to be fully compatible with NBC standards, including for washability and survivability. In one embodiment, the touch screen/display assembly 111 is a ruggedized assembly configured to endure ground combat requirements and environments, which includes NBC compatibility, without operational degradation from nuclear contamination, biological and chemical agents, decontamination agents, cleaning and spray down activities, submersion down to approximately three meters of water, and extreme temperature ranges and swings.

The touch screen 114 in the illustrated embodiment is an oversized touch screen that has “overhanging zones” that extend radially beyond the peripheral edges of the display portion of the display 110. Accordingly, the peripheral portions of the touch screen 114 are spaced lateral away from the peripheral portions of the display 110. In another embodiment, the touch screen 114 can be shaped and sized to substantially match the shape and size of the display portion of the display 110, such that the peripheral portions of the touch screen are positioned over peripheral portions of the display's working area. The touch screen/display assembly 111 is configurable to provide selected touch-receiving portions around the periphery of the touch screen 114, such as along the “overhanging zones.” The touch-receiving portions are configured to be activated by a “touch” action of a user, discussed in greater detail below, thereby providing a selected input signal to the display or the associated computer. The touch screen/display assembly 111 and/or the computer can be configured for a selected application (such as a mission specific application) to generate selected touch-receiving portions as selected positions on the touch screen 114. The touch screen/display assembly 111 and/or the computer can be reconfigured for a different application (such as a specific application for a different mission or use), so as to provide other touch-receiving portions on different portions of the touch screen, such as along selected areas adjacent to the periphery of the touch screen. This reconfiguration can be accomplished by running different applications or programs via the computer, such that the reconfiguration does not require any breach or other physical invasion of the sealed touch screen/display assembly 111 by simply replacing the bezel 130 and actuatable keys 128 from one mission specific configuration with a bezel 130 and the respective actuatable keys 128 of the next mission specific application.

The overlay 120, the keys 128, and the frame 130 are also attachable to the touch screen/display assembly 111 without affecting the sealed integrity of the assembly. The overlay 120, keys 128, and frame 130 are also compatible with NBC standards for washability and survivability. The overlay 120 can be partially covered by the frame 130, such that a covered portion 124 of the overlay is sandwiched between the frame and the touch screen. An exposed portion 126 of the overlay 120 radially inward of the covered portion is exposed through a window of the frame 130. The overlay 120 can cover the periphery of the touch screen 114 that includes the touch-receiving portions of the touch screen. In another embodiment, the overlay 120 can cover substantially the entire upper surface of the touch screen 114, including the touch receiving areas. The overlay system 100 can be sized to accommodate virtually any touch screen/display assembly 111 size.

FIG. 1B illustrates a partially exploded view of the overlay system 100 of FIG. 1A according to several embodiments. In the illustrated embodiment, the touch screen 114 is positioned top the display 110 such that a substantially complete viewing portion of the display is visible to a user through the touch screen. The overlay 120 is positioned above the touch screen 114 and the frame 130 (also referred to as a bezel) is positioned above the overlay 120, such that the overlay 120 is between the frame 130 and the touch screen 114.

As best seen in FIGS. 1B-1D, the frame 130 of the illustrated embodiment sandwiches an outer periphery of the overlay 120 against the top surface of the touch screen 114, such that the overlay has a covered peripheral area 124 and an exposed area 126 radially inward of the covered peripheral area 124. The overlay 120 includes a plurality of keys 128 in selected locations on the exposed portion 126 that correspond to the touch-receiving portions of the touch screen. The keys 128 can be configured as buttons, simulated switches, or other selected input features. The keys 128 are configured to allow a user to press or otherwise touch the keys 128, and the keys transfer the touch to the respective touch-receiving portion on the touch screen, thereby activating the touch-receiving portion and the corresponding function associated with that touch-receiving portion.

As indicated above, the touch screen/display 111 can be configured, as an example, for a mission specific application that includes selected display options and selected locations of the touch-receiving portions. In one embodiment, a mission specific or function specific overlay can be attached to the touch screen/display assembly 111 with keys 128 positioned to correspond to the location of the touch-receiving portions. When the touch screen/display 111 is reconfigured for a different application with different display options and/or touch-receiving portions, the first overlay configured for the first mission specific application can be quickly and easily removed and replaced with another overlay 120 with keys 128 configured for use with the different application and the different touch-receiving portions. In other embodiments, one overlay 120 can be configured with multiple keys 128 that can be used with multiple display options and the associated locations of the touch-receiving portions on the touch screen.

This display overlay system 100 provides substantial flexibility both in use in the field and during product development. The display overlay system 100 can utilized the overlays 120 to provided fixed function switch nomenclature of an integrated illuminated switch panel display assembly. The display overlay system 100 also allows the overlays 120 to be quickly and easily reconfigured or replaced throughout product development of the touch screen/display assembly 111, such as during software development, prototyping, final product layout, etc. Accordingly, the display overlay system 100 provides for reconfigurable fixed function switch nomenclature, NBC compatibility, quick and reduced expense prototyping of software switch function development, field reconfigurability, and nomenclature transillumination. The system 100 can also be used as a development tool to allow a manufacturer or customer to develop switch function scenarios during product concept development. The manufacturer (or customer) can then specify, as an example, hard key tactile responsive versions of the final product configuration, or the manufacturer/customer can elect to utilize a product in the field that includes selected overlays 120 on the touch screen/display assembly 111.

In one embodiment, the keys 128 are integral to the overlay, and the keys 128 can be indicia printed or otherwise applied onto the surface of the overlay 120. The keys 128 can be flat and smooth so as to be visually detectable and substantially undetectable by feel alone. In other embodiments, some or all of the keys 128 can include some relief such the keys 128 are detectable visually and also by feel. In yet other embodiments, the keys 128 can be configured to provide tactile feedback or other haptic response when actuated. The keys 128 can also be configured to provide audible feedback to the user when actuated. For example, the keys 128 can deflect, move, flex, deform, or otherwise undergo an identifiable tactile change when actuated in a way that can be felt by a human finger or another pointing device to confirm to a user that the key 128 has been successfully pressed so as to engage the touch screen and activate the selected touch-receiving portion.

As shown in FIG. 1D, the overlay 120 can include a plurality of flexible raised portions 129 that can have a space below the raised portion 129. When a user depresses the keys 128, the flexible nature of the key 128 allows the key 128 to at least partially collapse, deflect downward and the back side of the key 128 engages the corresponding touch-receiving portion of the touch screen 114. The keys 128 can be released and resiliently return to its released or un-pressed position automatically when the user removes sufficient pressure from the key. In addition to providing the user with tactile feedback, or other haptic response, regarding depression of the keys 128, the raised keys also provide raised portions on the overlay that allow the user feel the key 128 without having to visually identify the location of the key 128. The keys 128 can be configured to provide one or more other haptic responses upon actuation, such as flexing, buckling, bending, snapping, vibrating, sliding, moving, changing of frictional feel, changing of pressure or force resistance, or other tactile changes. The overlay 120 can also have an audible response component for some or all of the keys, such as a click or a noise. The audible response can be mechanically produced by the structure of the overlay 120 and the keys 128, or digitally simulated, or some combination of mechanical and digital simulation.

There are various types of touch screen modules 114 that are actuated in different ways. For example, the touch screen module 114 can be resistive, projective capacitive, capacitive, infrared, a surface acoustic wave (SAW), or any other suitable type of touch screen module 114. In any case, the keys 128 can appropriately operate the touch screen module 114. In other words, the overlay 120 does not inhibit actuation of the touch screen module 114. In many applications a simple touch screen display without tactile feedback is not appropriate. For example, in many military situations personnel frequently are wearing gloves or are not in a position to operate a touch screen without a tactile feedback. In addition, some people may not have been properly trained to use selected touch screen displays and therefore a tactile feedback is advantageous.

The overlay 120 of the illustrated embodiment is made of a flexible, durable, and NBC compatible material, such an elastomer, plastic or other selected material. The overlay 120 can be opaque, translucent or transparent. For example, the overlay 120 can have a substantially opaque boarder that corresponds to a portion of the touch screen 114 that surrounds the visual display portion of the display 110. The keys 128 can be mostly opaque and have translucent or transparent indicia such that light from the display illuminates through the key 128 to label the key 128. In other embodiments the overlay 120 has no indicia and is completely translucent or transparent and the display 110 produces the indicia on screen which is legible through the touch screen 114 and/or the key 128. The display overlay system 100 can include one or more light elements 112 or other illuminating device positioned below peripheral portions of the touch screen such that light will pass through the touch screen and illuminate the keys 128 or selected portions of the keys 128. In another embodiment, the light element 112 may be provided below a portion of the display that is aligned with a selected portion of the touch screen (as shown in phantom lines in FIG. 1C), such that light can be provided through the display and the touch screen to illuminate the keys 128, portions of the keys, or selected portions of the overlay. In at least one embodiment, the display may be configured to at least partially control characteristics of the light passing to the touch screen, keys and/or overlay. For example, the display could be configured to control the color or intensity of the light provided through the touch screen, keys, and/or overlay. In yet another embodiment, the characteristics of the light can be controlled by the light element(s) 112 discussed above. In some embodiments the overlay 120 and/or the frame 130 are configured to comply with NBC standards for washability, maintenance and repair. In particular, some standards specify certain material attributes that prevent contaminants from adhering to the material. For example, certain crevice size can be specified at certain dimensions and tolerances to prevent contaminants from entering the crevice, and to facilitate washing of the device or equipment. The overlay system 100 of the present disclosure can be easily disassembled by removing the frame 130 and overlay 120 and washing them separately. In other embodiments, the overlay 120 and/or the frames 130 are disposable, such that they can be removed from the touch screen/display assembly 111, thrown away, and a new, clean overlay and frame can be quickly and easily installed on the touch screen/display assembly 111.

In other embodiments, the display overlay system 100 can be a reconfigurable mobile modular unit configured for use in a reconfigurable dashboard assembly, such as the one disclosed in U.S. Pat. No. 7,823,952, titled “Reconfigurable Dashboard Assembly For Military Vehicles”, issued Nov. 2, 2010, and which is incorporated herein by reference thereto. The display overlay system 100 can be quickly and easily reconfigured for mission specific uses. In one embodiment, the display overlay system 100 can be reconfigured by removing and replacing the overlay and/or the frame while the system 100 remains installed in the vehicle. In other embodiments, the system 100 can be removed from the vehicle as a modular unit and reconfigured while removed from the vehicle.

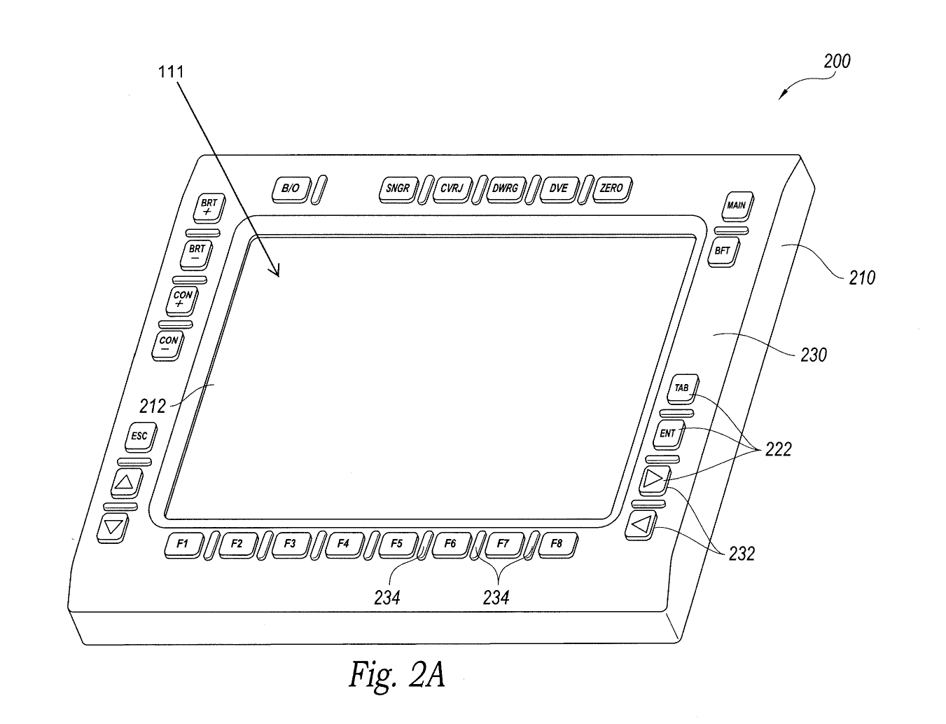

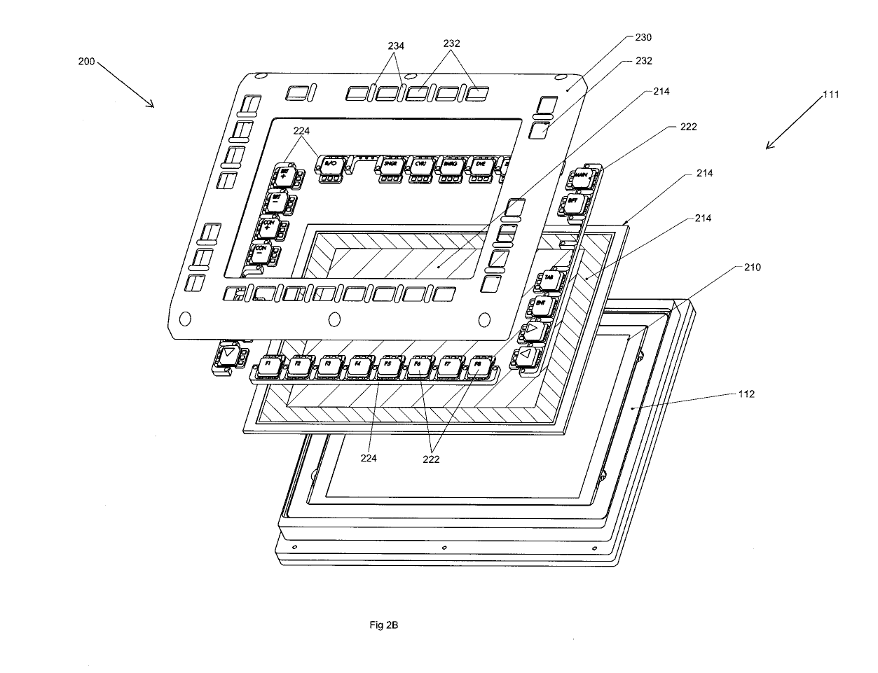

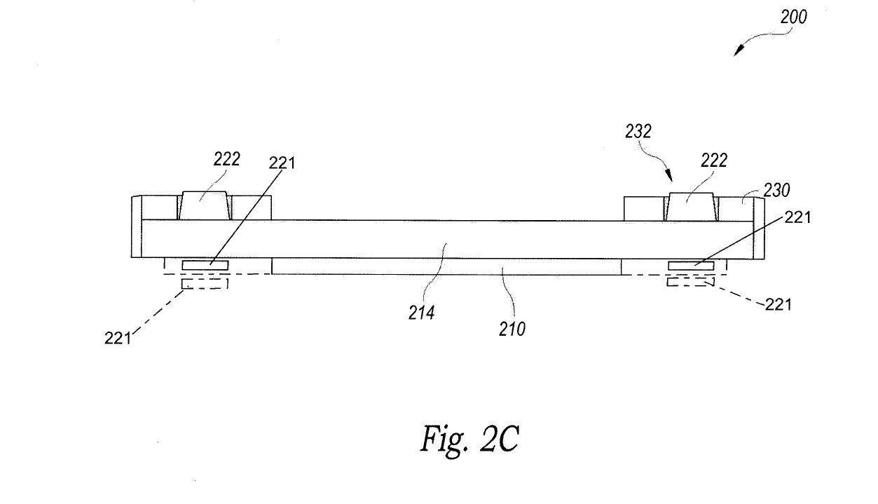

FIG. 2A illustrates a touch screen display system 200 according to a further embodiment of the present disclosure. FIG. 2B illustrates an exploded view of the touch screen display system 200. The touch screen display system 200 can include a display assembly 210 coupleable to a ruggedized computer, a touch screen 214 (such as an oversized touch screen as discussed above) atop and sealably coupled to the display assembly, a plurality of discrete, individual, modular, actuatable keys 222, and a bezel or frame 230. The frame 230 includes several apertures 232 that receive individual keys 222 or groups of keys 222. In one embodiment, the frame 230 carries the keys 222 and positions the keys on or immediately adjacent to the top surface of the touch screen 214 or a protective overlay positioned between the keys and the touch screen. With the frame 230 positioned on the touch screen 214, the keys 222 fit within the apertures 232 and are actuatable within the frame 230 so as to press or otherwise activate the selected portions of the touch screen 214 radially outward of the display active area.

The keys 222 can project a slight distance beyond the surface of the frame 230 to provide tactile and visual features useable by the operator. The keys 222 can be flexible, depressible, or otherwise actuatable. Similar to the keys 128 discussed above, the keys 222 can provide a haptic response and/or audible feedback when depressed. For example, the keys 222 can have a measure of resistance when pressed by a human finger or another pointing device and return to form when released, and/or can make a clicking noise. The frame 230 can be positioned over a portion of the touch screen 214 such that the apertures 232 are positioned over selected touch-receiving portions in an input region around the peripheral regions of the oversized touch screen 214.

The keys 222 can be compatible with any suitable type of touch screen 214, so that a user can actuate the touch screen operations through they keys 222. In some embodiments the frame 230 includes a plurality of raised partitions or separators 234 between each aperture 232 to further help a user identify between keys 222 by touch. In some embodiments, the area between the keys 222 and the top surface of the touch screen 214 is open to wash down and decontamination via mechanical or fluidic techniques.

In another embodiment, the frame 230 and the keys 222 are removable from the touch screen/display assembly 111, disposable, and replaceable with a new frame and keys. The new frame 230 can have the same arrangement of apertures and carry the same number of keys. Alternatively, the new frame can have a different arrangement of apertures, and the frame can carry or otherwise connect to a different arrangement of keys, such as to correspond to a different arrangement of touch-receiving portions on the peripheral portion of the touch screen. This arrangement allows the display overlay system 200 to have reconfigurable, nomenclature or functions in the field. The system 200 can also be used for facilitating product development, prototyping and testing. For example, a manufacturer or customer can select and test potential switch function scenarios during product concept development. The removable, replaceable frame and keys arrangement can be quickly switched during testing or development without costly hard key rework and associated time delays. The manufacturer or customer can select the final key arrangement, and can specify a hard key tactile responsive configuration for the final product. Alternatively, the manufacturer can incorporate the removable frame and keys in the final product configuration.

In addition, keys 222 can be individually placed at various positions in individual apertures 232 according to a mission specific design or operation. In some embodiments the keys 222 can be formed in groups of one, two, three, four, eight or another suitable number of keys in a key package 224. Accordingly, the display overlay system 200 utilizes “switching” features that can be provided by the touch screen/display assembly 111 thereby eliminating the need for additional switching technology often uniquely associated with conventional keycaps.

FIG. 2C illustrates a cross-sectional view of the system 200 according to embodiments of the present disclosure. As discussed above, the actuatable keys 222 can be positioned within an aperture 232 within the frame 230. There can be a space in the aperture 232 sufficient to accommodate the key 222 within the aperture 232. In some embodiments the keys 222 can project slightly above a surface of the bezel or frame 230. Similar to other embodiments the keys 222 can be translucent or transparent partially or completely to allow for indicia to be provided on the keys 222. In some embodiments the keys are completely translucent such that indicia provided by the display 210 below the touch screen can be read through the keys 222. In other embodiments the keys can have translucent portions forming written indicia and the lighting element 221 can shine through the keys 222 forming a legible label on each key 222. The lighting element 221 can be positioned under selected portions of the touch screen (e.g., peripheral portions of the touch screen) or under selected portions of the display, as discussed above and as shown in phantom lines in FIG. 2C.

The modular design of the keys 222 and the frame 230 allows for the overlay system 200 to be changed for a mission-specific use or as conditions in the field change to accommodate changing needs. The content shown by the display 210 can also be flexible as is known in the art, allowing for a reconfigurable modular and changeable display system that is relatively inexpensive to produce and is compatible with NBC standards.

Appendix A includes isometric views, top views, bottom views, left side views, right side views, front side views, and rear side views showing ornamental designs of the systems disclosed herein.

As indicated above, the display overlay systems disclosed herein are configured to be operatively coupled to a computer. Such a computer may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

From the foregoing, it will be appreciated that specific embodiments of the invention have been described herein for purposes of illustration, but that various modifications may be made without deviating from the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally, not all embodiments need necessarily exhibit such advantages to fall within the scope of the invention. Accordingly, the invention is not limited except as by the appended claims.

1-21. (canceled)

22. A reconfigurable display system for providing an operator interface with a vehicle-mounted system computer, the reconfigurable display system comprising:
a housing;
a display connectable to the vehicle-mounted system computer;
a touchscreen sealably coupled with the display and connectable to the vehicle-mounted system computer;
a removable overlay on a periphery of the touchscreen; and
a frame detachably coupled to the housing, and sandwiching the display, the touchscreen, and the removable overlay therebetween,
wherein—
the frame defines a first window,
the removable overlay includes a sheet of flexible material having an exposed portion defining a second window, and a covered portion held between the frame and the periphery of the touchscreen,
the exposed portion of the removable overlay includes a plurality of actuatable keys operably coupled with corresponding touch portions of the touchscreen, and
the touchscreen includes a top surface exposed and directly accessible through the first and second windows.

23. The display system of claim 22 wherein:
the removable overlay is a first removable overlay;
the touch portions are first touch portions associated with a first mission specific application hosted by the vehicle-mounted system computer; and
the display system further comprises a second removable overlay interchangeable with the first removable overlay, wherein the second removeable overlay includes a plurality of actuatable keys configured to contact corresponding second touch portions of the touchscreen associated with a second mission specific application hosted by vehicle-mounted system computer.

24. The display system of claim 23 wherein each of the actuatable keys is configured to provide a haptic response upon actuation.

25. The display system of claim 23 wherein the removable overlay is formed from a sheet of resilient material.

26. The display system of claim 25 wherein each of the actuatable keys is integral with the sheet of resilient material.

27. The display system of claim 25 wherein each of the actuatable keys includes a raised portion integral with the sheet of resilient material.

28. The display system of claim 25 wherein the resilient material is transparent.

29. The display system of claim 23 wherein the periphery of the touchscreen extends beyond a periphery of the display.

30. The display system of claim 22 wherein the frame and the removable overlay are independently washable and decontaminatable in accordance with nuclear, biological, and chemical (NBC) regulations for washability and survivability.

31. A reconfigurable display system for providing an operator interface with a system computer, the reconfigurable display system comprising:
a sealed touchscreen display assembly;
a frame defining a first opening over the touchscreen display assembly; and
a flexible overlay held between the frame and the touchscreen display assembly, wherein the flexible overlay includes—
a first region pressed against the touchscreen display assembly by the frame, and
a second region integral with the first region and exposed through the first opening of the frame,
wherein—
the second region of the flexible overlay defines a second opening exposing a portion of the touchscreen display assembly, and a plurality of actuatable keys surrounding the second opening of the second region,
the plurality of actuatable keys are operably coupled to corresponding touch portions of the touchscreen display assembly, and
each of the actuatable keys is configured to provide haptic feedback to the operator upon actuation.

32. The display system of claim 31 wherein:
the flexible overlay is a first flexible overlay;
the plurality of actuatable keys are a plurality of first actuatable keys;
the first plurality of actuatable keys is associated with a first mission specific application hosted by the computer; and
the system further comprises a second flexible overlay interchangeable with the first flexible overlay, wherein the second flexible overlay includes a plurality of second actuatable keys associated with a second mission specific application hosted by the computer.

33. The display system of claim 32 wherein the plurality of first actuatable keys is in a first arrangement, and the plurality of second actuatable keys is in a second arrangement different than the first arrangement.

34. The display system of claim 32 wherein each of the first actuatable keys has a first tactile response, and each of the second actuatable keys has a second tactile response that is different than the first tactile response.

35. The display system of claim 31 wherein the flexible overlay includes a sheet of flexible material, and wherein the actuatable keys are integral with the sheet of flexible material.

36. The display system of claim 31, further comprising a housing, wherein at least the touchscreen display is positioned in the housing, and wherein the frame is detachably mounted to the housing.

37. The display system of claim 36 wherein the housing, the touchscreen display, the flexible overlay, and the frame are configured to be installed on a portion of a vehicle dashboard, wherein the frame and the flexible overlay are independently replaceable after installation.

38. The display system of claim 36 wherein the frame, the flexible display, and the touchscreen display assembly are independently washable in accordance with nuclear, biological, and chemical (NBC) regulations.

39. The display system of claim 31 wherein the sealed touchscreen display assembly includes a display and a touchscreen operably coupled to the display, wherein the touchscreen is oversized relative to the display.
